(19) United States
(12) Patent Application Publication
(10) Pub. No.: US 2009/0083416 A1
(43) Pub. Date: Mar. 26, 2009

(54) METHODS TO VERIFY WIRELESS NODE PLACEMENT FOR RELIABLE COMMUNICATION IN WIRELESS SENSOR CONTROL NETWORKS

(75) Inventors: Geoffrey D. Nass, Rolling Meadows, IL (US); Pornsak Songkakul, Mequon, WI (US); Jeffrey A. Raimo, Winnetka, IL (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Building Technologies, Inc.

(21) Appl. No.: 12/135,670

(22) Filed: Jun. 9, 2008

Related U.S. Application Data
(60) Provisional application No. 60/994,443, filed on Sep. 20, 2007.
(60) Provisional application No. 60/994,441, filed on Sep. 20, 2007.

(51) Int. Cl. G06F 15/16; G06F 15/177

(52) U.S. Cl. 709/224

(57) ABSTRACT

In one exemplary embodiment, a method of verifying placement of automation components configured for use within a building automation system is disclosed. The method includes determining a wireless communication channel for use within a building automation system, polling a plurality of automation components deployed within the building automation system, wherein each of the plurality of automation components utilizes the wireless communication channel for communication, determining communication parameters associated with each of the plurality of automation components, and adjusting the deployment of at least one of the plurality of automation components in response to the determined communication parameters.

### CROSS-REFERENCE TO RELATED APPLICATIONS

This patent claims the priority benefit under 35 U.S.C. §119(e) of U.S. provisional patent application Ser. No. 60/994,443 (2007P19472US), filed on Sep. 19, 2007, and U.S. provisional patent application Ser. No. 60/994,441 (2007P19574US), filed on Sep. 19, 2007, the content of which are hereby incorporated by reference for all purposes.

This patent relates to co-pending U.S. patent application U.S. patent application Ser. No. ______, titled “METHOD AND TOOL FOR WIRELESS COMMUNICATIONS WITH SLEEPING DEVICES IN A WIRELESS SENSOR CONTROL NETWORK”, filed contemporaneously herewith, the content of this applications are incorporated by reference for all purposes.

This patent further relates to co-pending U.S. patent application Ser. No. 11/590,157 (2006P18573 US), filed on Oct. 31, 2006, and co-pending U.S. patent application Ser. No. 10/915,034 (2004P13093 US), filed on Aug. 8, 2004, the contents of these applications are hereby incorporated by reference for all purposes.

### BACKGROUND

The present disclosure generally relates to wireless mesh networks operating within a building automation system. In particular, the present disclosure relates to methods and apparatuses for verifying the physical placement and layout of wireless devices within the building automation system to ensure reliable operation.

A building automation system (BAS) typically integrates and controls elements and services within a structure such as the heating, ventilation and air conditioning (HVAC) system, security services, fire systems and the like. The integrated and controlled systems are arranged and organized into one or more field level networks (FLNs) containing application or process specific controllers, sensors, actuators or other devices distributed to define or establish a network. The field level networks provide general control for a particular floor or region of the structure. For example, a field level network may be an RS-485 compatible network that includes one or more controllers or application specific controllers configured to control the elements or services within floor or region. The controllers may, in turn, be configured to receive an input from a sensor or other device such as, for example, a room temperature sensor (RTS) deployed to monitor the floor or region. The input, reading or signal provided to the controller, in this example, may be a temperature indication representative of the physical temperature. The temperature indication can be utilized by a process control routine such as a proportional-integral control routine executed by the controller to drive or adjust a damper, heating element, cooling element or other actuator towards a predefined set-point.

Information such as the temperature indication, sensor readings and/or actuator positions provided to one or more controllers operating within a given field level network may, in turn, be communicated to an automation level network (ALN) or building level network (BLN) configured to, for example, execute control applications, routines or loops, coordinate time-based activity schedules, monitor priority based overrides or alarms and provide field level information to technicians. Building level networks and the included field level networks may, in turn, be integrated into an optional management level network (MLN) that provides a system for distributed access and processing to allow for remote supervision, remote control, statistical analysis and other higher level functionality. Examples and additional information related to BAS configuration and organization may be found in the co-pending U.S. patent application Ser. No. 11/590,157 (2006P18573 US), filed on Oct. 31, 2006, and co-pending U.S. patent application Ser. No. 10/915,034 (2004P13093 US), filed on Aug. 8, 2004, the contents of these applications are hereby incorporated by reference for all purposes.

Wireless devices, such as devices that comply with IEEE 802.15.4/ZigBee protocols, may be implemented within the control scheme of a building automation system without incurring additional wiring or installation costs. ZigBee-compliant devices such as full function devices (FFD) and reduced function devices (RFD) may be interconnected to provide a device net or mesh within the building automation system. For example, full function devices are designed with the processing power necessary to establish peer-to-peer connections with other full function devices and/or execute control routines specific to a floor or region of a field level network. Each of the full function devices may, in turn, communicate with one or more of the reduced function devices in a hub and spoke arrangement. Reduced function devices such as the temperature sensor described above are designed with limited processing power necessary to perform a specific task(s) and communicate information directly to the connected full function device.

### SUMMARY

The present disclosure generally provides for ensuring that wireless devices are configured, deployed and able to communicate with each other when operating within a building automation system (BAS). A mobile wireless device or tool may be configured and utilized to manually or automatically verify and/or optimize the placement of wireless devices and/or automation components within the BAS.

In one exemplary embodiment, a method of verifying placement of automation components configured for use within a building automation system is disclosed. The method includes determining a wireless communication channel for use within a building automation system, polling a plurality of automation components deployed within the building automation system, wherein each of the plurality of automation components utilizes the wireless communication channel for communication, determining communication parameters associated with each of the plurality of automation components, and adjusting the deployment of at least one of the plurality of automation components in response to the determined communication parameters.

In another embodiment, a mobile device for verifying placement of automation components within a building automation system is disclosed. The device including a processor in communication with a memory. The processor configured to determine a wireless communication channel for use within a building automation system in response to a communicated scan command, poll a plurality of automation components deployed within the building automation system, wherein each of the plurality of automation components utilizes the wireless communication channel for communication, and determine communication parameters associated with each of the plurality of automation components.

Additional features and advantages of the present invention are described in, and will be apparent from, the following Detailed Description and the figures.

### BRIEF DESCRIPTION OF THE FIGURES

The method, system and teaching provided relate to verify and ensure communications between automation components operating within a building automation system (BAS).

FIG. 1 illustrates an embodiment of a building automation system configured in accordance with the disclosure provided herein;

FIG. 2 illustrates an embodiment of a wireless device or automation component that may be utilized in connection with the building automation system shown in FIG. 1;

FIG. 3 illustrates an exemplary physical layout for a field level network including one or more automation components and/or mesh networks;

FIG. 4 illustrates a mobile device for use in verifying communications between one or more automation components and/or mesh networks; and

FIG. 5 illustrates an exemplary flowchart representative of a communication verification algorithm.

### DETAILED DESCRIPTION

The embodiments discussed herein include automation components, wireless communication components and/or transceivers. The devices may be IEEE 802.15.4/ZigBee-compliant automation components such as: a personal area network (PAN) coordinator which may be implemented as a field panel transceiver (FPX); a full function device (FFD) implemented as a floor level device transceiver (FLNX); and a reduced function device (RFD) implemented as a wireless room temperature sensor (WRTS) that may be utilized in a building automation system (BAS). The devices identified herein are provided as an example of automation components, wireless devices and transceivers that may be integrated and utilized within a building automation system embodying the teachings disclosed herein and are not intended to limit the type, functionality and interoperability of the devices and teaching discussed and claimed herein. Moreover, the disclosed building automation system describes automation components that may include separate wireless communication components and transceivers, however it will be understood that that the wireless communication component and transceiver may be integrated into a single automation component operable within the building automation system.

One exemplary building automation system that may include the devices and be configured as described above is the APOGEE® system provided by Siemens Building Technologies, Inc. The APOGEE® system may implement RS-485 wired communications, Ethernet, proprietary and standard protocols, as well as known and/or foreseeable wireless communications standards such as, for example, IEEE 802.15.4 wireless communications which are compliant with the ZigBee standards and/or ZigBee certified wireless devices or automation components. ZigBee standards, proprietary protocols or other standards are typically implemented in embedded applications that may utilize low data rates and/or require low power consumption. Moreover, ZigBee standards and protocols are suitable for establishing inexpensive, self-organizing, mesh networks which may be suitable for industrial control and sensing applications such as building automation. Thus, automation components configured in compliance with ZigBee standards or protocols may require limited amounts of power allowing individual wireless devices, to operate for extended periods of time on a finite battery charge.

The wired or wireless devices such as the IEEE 802.15.4/ZigBee-compliant automation components may include, for example, an RS-232 connection with an RJ-11 or other type of connector, an RJ-45 Ethernet compatible port, and/or a universal serial bus (USB) connection. These wired, wireless devices or automation components may, in turn, be configured to include or interface with a separate wireless transceiver or other communications peripheral thereby allowing the wired device to communicate with the building automation system via the above-described wireless protocols or standards. Alternatively, the separate wireless transceiver may be coupled to a wireless device such as a IEEE 802.15.4/ZigBee-compliant automation component to allow for communications via a second communications protocol such as, for example, 802.11x protocols (802.11a, 802.11b . . . 802.11n, etc.) or any other communication protocol. These exemplary wired, wireless devices may further include a man-machine interface (MMI) such as a web-based interface screen that provide access to configurable properties of the device and allow the user to establish or troubleshoot communications between other devices and elements of the BAS.

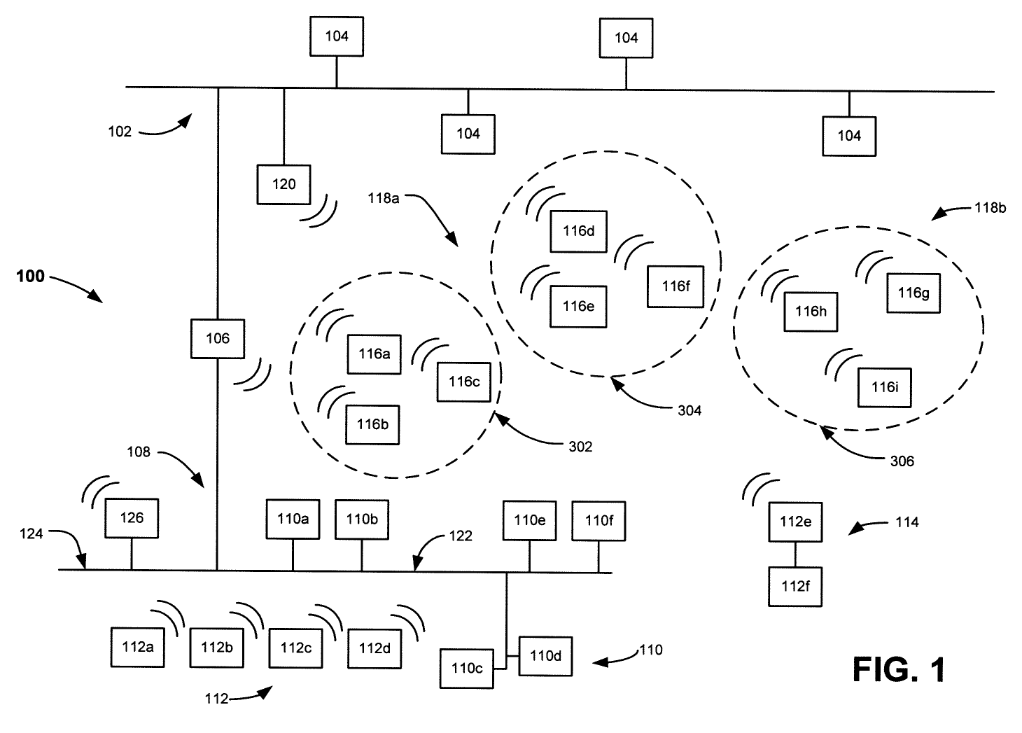

FIG. 1 illustrates an exemplary building automation system or control system 100 that may incorporate the methods, systems and teaching provided herein. The control system 100 includes a first network 102 such as an automation level network (ALN) or management level network (MLN) in communication with one or more controllers such as a plurality of terminals 104 and a modular equipment controller (MEC) 106. The MEC or controller 106 is a programmable device which may couple the first network 102 to a second network 108 such as a field level network (FLN). The first network 102 may be wired or wirelessly coupled or in communication with the second network 108. The second network 108, in this exemplary embodiment, may include a first wired network portion 122 and a second wired network portion 124 that connect to building automation components 110 (individually identified as automation components 110a to 110f). The second wired network portion 124 may be coupled to wireless building automation components 112 via the automation component 126. For example, the building automation components 112 may include wireless devices individually identified as automation components 112a to 112f. In one embodiment, the automation component 112f may be a wired device, that may or may not include wireless functionality, that connects to the automation component 112e. In this configuration, the automation component 112f may utilize or share the wireless functionality provided by the automation component 112e to define an interconnected wireless node 114. The automation components 112a to 112f may, in turn, communicate or connect to the first network 102 via, for example, the controller 106 and/or an automation component 126. The automation component 126 may be a field panel, FPX or another full function device in communication with the second wired network portion 124 which, in turn, may be in communication with the first network 102.

The control system 100 may further include automation components 116 which may be individually identified by the reference numerals 116a to 116i. The automation components 116a to 116i may be configured or arranged to establish one or more wireless sensor and control networks (WSCN) such as the mesh networks 118a and 118b. The automation components 116a to 116i such as, for example, full or reduced function devices and/or configurable terminal equipment controllers (TEC), may cooperate to wirelessly communicate information between the first network 102, the control system 100 and other devices within the mesh networks or subnets 118a and 118b. For example, the automation component 116a may communicate with other automation components 116b to 116f within the mesh network 118a by sending a message addressed to the network identifier, alias and/or media access control (MAC) address assigned to each of the interconnected automation components 116a to 116f and/or to a field panel 120. In one configuration, the individual automation components 116a to 116f within the mesh network 118a may communicate directly with the field panel 120 or alternatively, the individual automation components 116a to 116f may be configured in a hierarchal manner such that only one of the components, for example, automation component 116c, communicates with the field panel 120. The automation components 116g to 116i of the mesh network 118b may, in turn, communicate with the individual automation components 116a to 116f of the mesh network 118a or the field panel 120.

The automation components 116a to 116i deployed within the mesh networks 118a, 118b may be battery-powered long life devices configured to “sleep” or remain in a low powered state. Alternatively, one or more of the one or more of the automation components 116 a to 116i may be line-powered devices configured to remain “awake” all of the time. For example, the controller 106 may be a line powered “parent” to the “children” devices, which in this example are the automation components 116a to 116f, of the mesh network 118a. When, for example, the automation component 116a, which may be a battery powered device, awakens from a predefined sleep period, it may be configured to poll or communicate with the parent controller 106. The polling or communications between the automation component 116a and the controller 106 serves, in this example, to transfer any messages, commands and/or instructions stored on the controller 106 which may have been directed towards the automation component 116a during the predefined sleep period.

The automation components 112e and 112f defining the wireless node 114 may wirelessly communicate with the second network 108, and the automation components 116g to 116i of the mesh network 118b to facilitate communications between different elements, sections and networks within the control system 100. Wireless communication between the individual automation components 112, 116 and/or the mesh networks 118a, 118b may be conducted in a direct or point-to-point manner, or in an indirect or routed manner through the nodes or devices comprising the nodes or networks 102, 108, 114 and 118. In an alternate embodiment, the first wired network portion 122 is not provided, and further wireless connections may be utilized.

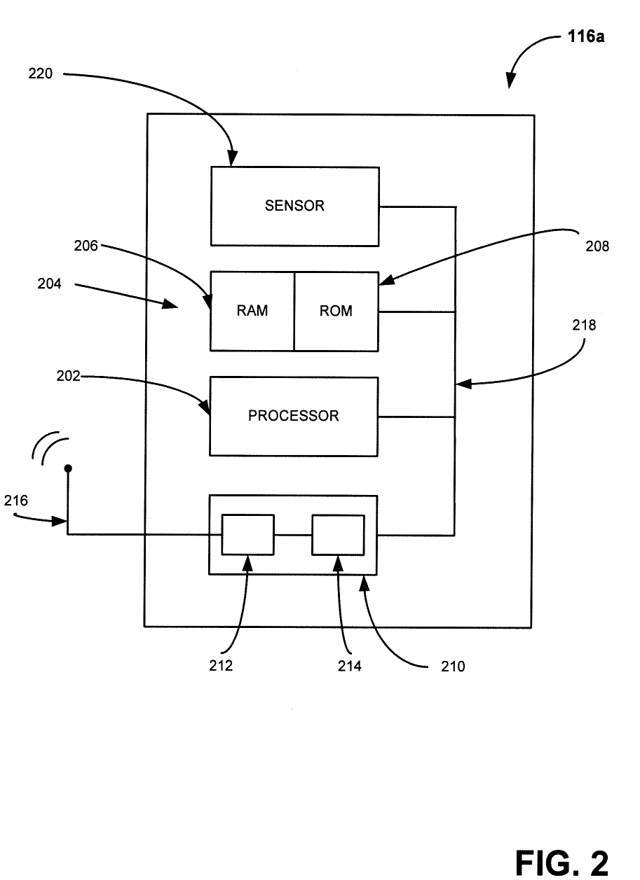

FIG. 2 illustrates an exemplary detailed view of one automation component 116a to 116i. In particular, FIG. 2 illustrates the automation component 116a. The automation component 116a may be a full function device or a reduced function device. While the automation component 116a is illustrated and discussed herein, the configuration, layout and componentry may be utilized in connection with any of the automation components deployed within the control system 100 shown and discussed in connection with FIG. 1. The automation component 116a in this exemplary embodiment may include a processor 202 such as an INTEL® PENTIUM®, an AMD® ATHLON® or other 8, 12, 16, 24, 32 or 64 bit classes of processors in communication with a memory 204 or storage medium. The memory 204 or storage medium may contain random access memory (RAM) 206, flashable or non-flashable read only memory (ROM) 208 and/or a hard disk drive (not shown), or any other known or contemplated storage device or mechanism. The automation component may further include a communication component 210. The communication component 210 may include, for example, the ports, hardware and software necessary to implement wired communications with the control system 100. The communication component 210 may alternatively, or in addition to, contain a wireless transmitter 212 and a receiver 214 (or an integrated transceiver) communicatively coupled to an antenna 216 or other broadcast hardware.

The sub-components 202, 204 and 210 of the exemplary automation component 116a may be coupled and configured to share information with each other via a communications bus 218. In this way, computer readable instructions or code such as software or firmware may be stored on the memory 204. The processor 202 may read and execute the computer readable instructions or code via the communications bus 218. The resulting commands, requests and queries may be provided to the communication component 210 for transmission via the transmitter 212 and the antenna 216 to other automation components 200, 112 and 116 operating within the first and second networks 102 and 108. Sub-components 202 to 218 may be discrete components or may be integrated into one (1) or more integrated circuits, multi-chip modules, and or hybrids.

The exemplary automation component 116a may be, for example, a WRTS deployed or emplaced within the structure. In operation, the WRTS may monitor or detect the temperature within a region or area of the structure. A temperature signal or indication representative of the detected temperature may further be generated by the WRTS. In another embodiment, the automation component 116a may be, for example, an actuator coupled to a sensor or other automation component. In operation, the actuator may receive a signal or indication from another automation component 116b to 116i and adjust the position of a mechanical component in accordance with the received signal. The command or indication may be stored or saved within the memory 204 for later processing or communication to another component within the control system 100.

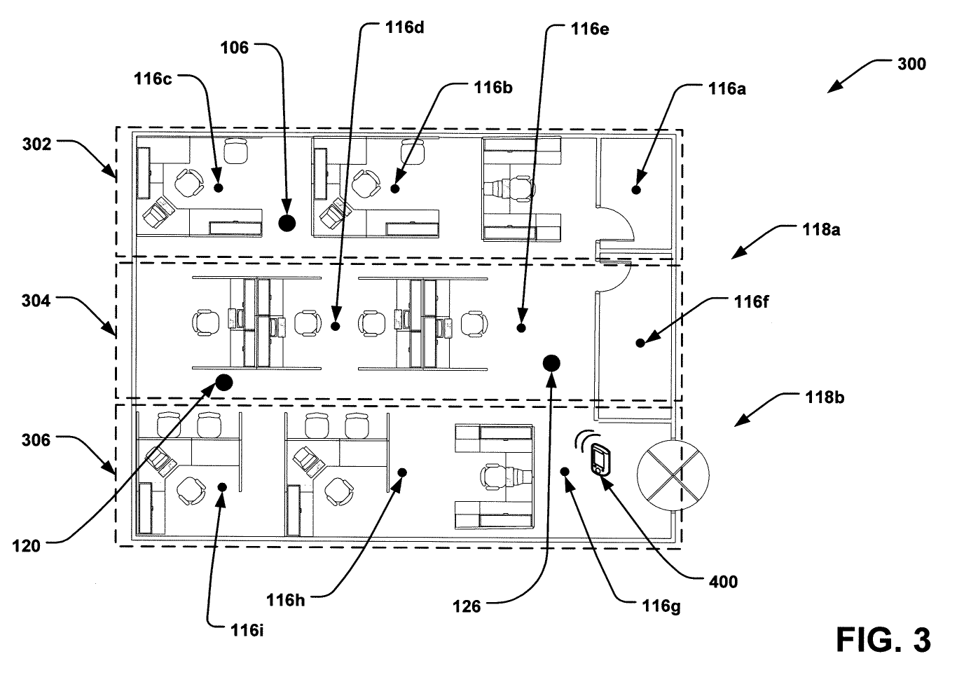

FIG. 3 illustrates an exemplary physical configuration 300 of automation components 116a to 116i that may be implemented in the control system 100. For example, the configuration 300 may represent a wireless FLN, such as the second network 108, including the first and second mesh networks 118a, 118b. The exemplary configuration 300 illustrates a structure in which the first mesh network 118a includes two zones 302 and 304 and the second mesh network 118b includes the zone 306. The zones, in turn, include automation components 116a to 116i. For example, zone 302 includes automation components 116a to 116c, zone 304 includes automation components 116d to 116f and zone 306 includes automation components 116g to 116i. Zones, mesh networks and automation components may be deployed within the structure in any know manner or configuration to provide sensor coverage for any space of interest therein.

As previously discussed, the automation components 116a to 116i may, in operation within the control system 100, be configured to control and monitor building systems and functions such as temperature, air flow, etc. In order to execute their intended functions within the control system 100, the deployed automation components 116a to 116i are required to communicate with each other and, for example, the controller 106, the field panel 120 and/or the automation component 126. In order to ensure the functionality of the control system 100, it is desirable to monitor and optimize the physical positions of the wireless devices, automation components, field panels, controllers, etc. operable therein. Moreover, verification and adjustment of the physical position of the wireless devices, automation components, field panels, controllers, etc. may prevent time-consuming and/or costly adjustments after the control system 100 is active and operating.

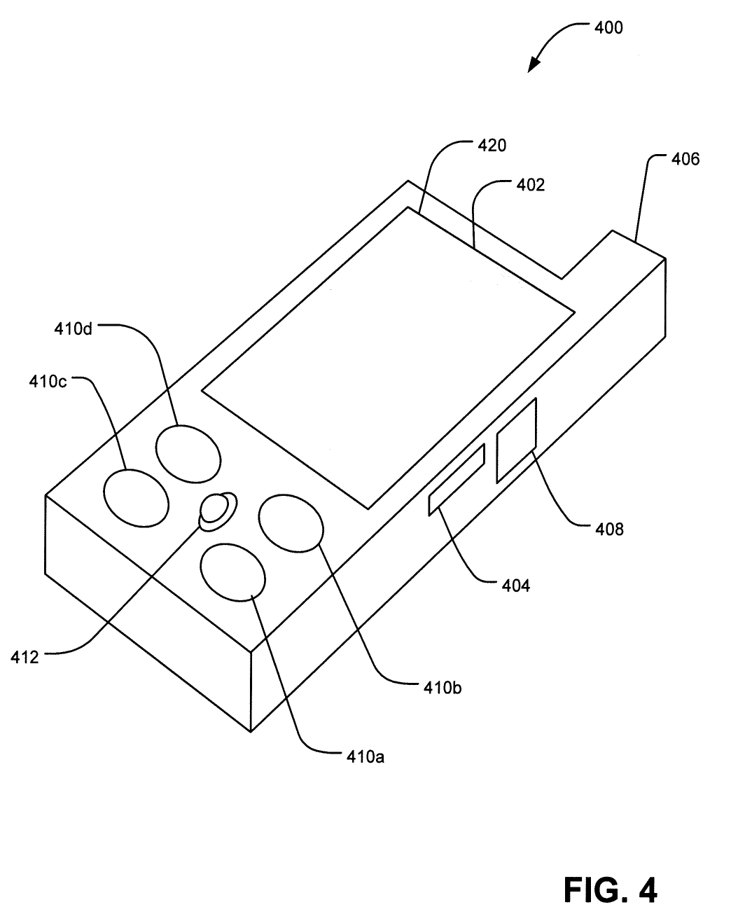

FIG. 4 illustrates an exemplary embodiment of the mobile tool or device 400 that may be utilized in cooperation with the one or more of the automation components 116a to 116i to perform site surveys, commission and diagnostic functions related to the configuration 300 and the control system 100.

The mobile device 400 may be, for example, a laptop computer, a personal digital assistant (PDA) or smart phone utilizing, for example, Advanced RISC Machine (ARM) architecture or any other system architecture or configuration. The mobile device 400, in this exemplary embodiment, may utilize one or more operating systems (OS) or kernels such as, for example, PALM OS®, MICROSOFT MOBILE®, BLACKBERRY OS®, SYMBIAN OS® and/or an open LINUX™ OS. These or other well known operating systems could allow programmers to create a wide variety of programs, software and/or applications for use with the mobile device 400.

The mobile device 400 may include a touch screen 402 for entering and/or viewing configuration information or data, a memory card slot 404 for data storage and memory expansion. The memory card slot 404 may further be utilized with specialized cards and plug-in devices such as, for example, a wireless networking card, to expand the capabilities of functionality of the mobile device 400. The mobile device 400 may include an antenna 406 to facility connectivity via one or more communication protocols such as: WiFi (WLAN); Bluetooth or other personal area network (PAN) standard; cellular communications and/or any other communication standard disclosed herein or foreseeable. The mobile device 400 may further include an infrared (IR) port 408 for communication via the Infrared Data association (IrDA) standard. The mobile device 400 may be configured and designed with a communication component similar to, and compatible with, the communication component 210 shown and discussed in connection with FIG. 2. The communication components utilized within the one or more of the automation components and the mobile device 400 may be selected and configured to be inter-compatible and compliant with any one of the communication protocols or standards discussed herein. The mobile device 400 may, in an embodiment, include or incorporate the components, elements and/or functionality deployed within the automation component 200 shown in FIG. 2.

Hard keys 410a to 410d may be provided to allow direct access to predefined functions or entrance of information via a virtual keyboard provided via the touch screen 402. The number and configuration of the hard keys may be varied to provide, for example, a full QWERTY keyboard, a numeric keyboard or any other desired arrangement. The mobile device 400 may further include a trackball 412, toggle or other navigation input for interaction with emergency information or data presented on the touch screen 402.

The mobile device 400 may be configured to communicate with the deployed automation components 116a to 116i and one or more of the controller 106, the field panel 120 and/or the automation component 126. Moreover, the mobile device 400 may be configured to communicate with the battery powered or “sleeping” devices, e.g., one or more of the automation components 116a to 116i, utilizing a special or dedicated “WAKEUP” command which may be transmitted directly from the mobile device 400 or via the controller 106, the field panel 120 and/or the automation component 126 associated with the sleeping automation component of interest.

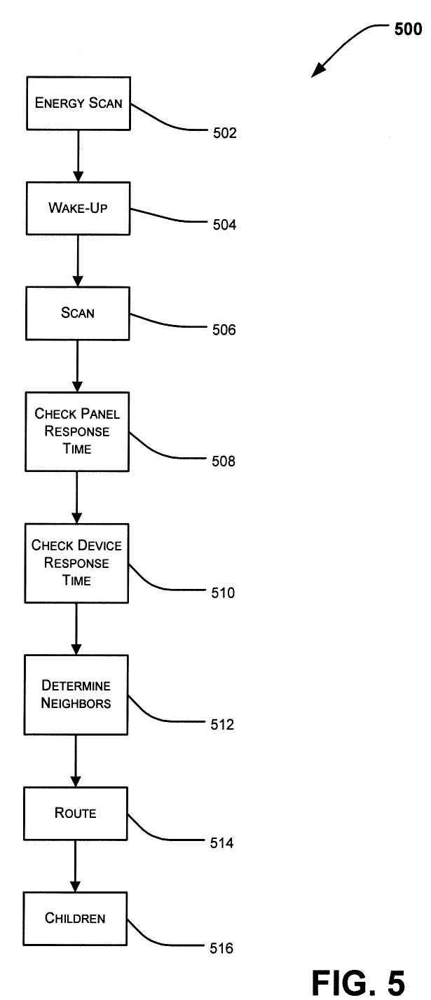

FIG. 5 illustrates a flowchart 500 detailing the exemplary operation of the mobile device 400 within the configuration 300. In particular, the flowchart 500 illustrates an exemplary method or algorithm for verifying that the automation components 116a to 116i (see FIG. 3) can reliably communicate with the controller 106, the field panel 120 and/or the automation component 126 (see FIG. 3), respectively or collectively. The method assisting in determining: (1) if the controller 106, the field panel 120 and/or the automation component 126, etc. are deployed or positioned close enough to communicate, (2) that building material or elements are not blocking or impeding wireless communications and (3) third party equipment is not generating an unacceptable amount of wireless interference.

At block 502, the mobile device 500 may be utilized to perform a baseline energy scan of the structure in which the control system is to be deployed. For example, the mobile device 400 may be configured to communicate via IEEE 802.15.4 or ZigBee standard. During the baseline energy scan, the mobile device 400 may identify and select a radio channel having minimal interference for communication within the control system 100.

At block 504, the full function devices such as, for example, the controller 106, the field panel 120 and/or the automation component 126 may be installed within the structure (see FIG. 3) and configured for operation within the control system 100. The mobile device 400 may communicate the “WAKEUP” command to all of the sleeping automation components 116a to 116i within the mesh networks 118a and 118b. The WAKEUP command may specify how frequently one or more of the automation components 116a to 116i transitions for “sleep” mode to “awake” mode to communicate with the mobile device 400 and how long a normal sleep/wake schedule should be overridden by the schedule communicated by the WAKEUP command.

At block 506, the mobile device 400 may communicate a “SCAN” command to one or more of the full function devices such as the controller 106, the field panel 120 and/or the automation component 126 operating via line power in the control system 100. The SCAN command ensures that each of the full function devices within the control system 100 can communicate with and respond to the mobile device 400 and each other. The SCAN command may further be utilized to verify and record the media access control (MAC) address and firmware version of each of the line powered full function devices. In operation, the SCAN command may cause both full function devices (which may be continually awake and ready to communicate) and reduced function devices (which may be inactive the majority of the time, but in response to the WAKEUP command may be active more frequently) to respond to the SCAN command. One or more intermediate automation components 116a to 116i, 120 and/or 126 may be deployed to act as a repeater component or node to relay the SCAN command to any reduced function devices or automation components 116 which may have been sleeping or inactive when the original SCAN command was initiated.

The blocks 508 to 516 illustrate commands and processes for determining and analyzing the configuration and reliability of the components or devices deployed within the control system 100. These communication commands and their associated communication parameters allow for a detailed analysis of communication and/or communications reliability within the control system.

At block 508, the mobile device 400 may communicate a “COMM” command to one or more of the full function devices such as the controller 106, the field panel 120 and/or the automation component 126 operating via line power in the control system 100. The COMM command may be utilized to verify the average response time including the average message completion percentage associated with each of the full function devices. If both of values for the average response time and average message completion percentage fall within the specification of the control system 100, wireless communication with the full function devices may be considered reliable. If one or more of the average wireless response times are too long, that can indicate a number of things such as one or more of the mesh networks 118a, 118b may be too large, e.g., there are too many hops (that consume extra time) between the source and destination devices, where the solution would be divide the larger wireless network into two or more physically smaller networks. Delayed or slow average wireless response times may further be caused by wireless interference, which causes the wireless messages to be delayed (waiting for an open communication gap) or lost (causing wireless message retries that consume extra time). One possible remedy to an interference-based delay may be to move to a different wireless channel with less interference, such as determined using the energy command discussed at block 502.

At block 510, the mobile device 400 may communicate a second “COMM” command. For example, the first COMM command may have been directed exclusively to full function devices, and the second COMM command may be directed to reduced function devices which may include one or more of the automation components 116a to 116i. The second COMM command may be utilized to verify the average response time including the average message completion percentage associated with each of the reduced function devices. If both of values for the average response time and average message completion percentage fall within the specification of the control system 100, wireless communication with the reduced function devices may be considered reliable. If the values for the average response time and average message completion percentage do not fall within the specification a repeater automation component or node may be added to improve the wireless communication link, or the network may be moved to another radio channel with less interference. Alternatively, the automation component may be physically relocated to provide a better wireless communication link.

At block 512, the mobile device 400 may communicate a “NEIGHBOR” command to each automation components, reduced function devices and full function devices within the mesh networks 118a and 118b. The NEIGHBOR command may be utilized to determine how many other automation components, reduced function devices, full function devices, etc. are associated with each automation component. The NEIGHBOR command identifies neighboring automation components for both outgoing and incoming wireless messages. The NEIGHBOR command identifies automation components associated with a limited number of (for example, two or less) automation components and/or automation components having weak communications links.

At block 514, the mobile device 400 may communicate a “ROUTE” command to each automation components, reduced function devices and full function devices within the mesh networks 118a and 118b. The ROUTE command may be utilized to determine the communication path or route followed by each message as it traverses through the mesh networks 118a and 118b and between the automation components 116a to 116i and the full function devices such as the controller 106, the field panel 120 and/or the automation component 126. The ROUTE command may be utilized to determine long paths or routes that may require the deployment of one or more repeater nodes or automation components to provide more direct routes with fewer time-consuming hops or relays.

At block 516, the mobile device 400 may communicate a “CHILDREN” command to each full function devices within the mesh networks 118a and 118b to determine the number of automation components and/or reduced function devices connected through a given full function device. Generally, it may be desirable to couple six (6) or fewer automation components and/or reduced function devices to each of the full function devices such as the controller 106, the field panel 120 and/or the automation component 126. If a parent automation component or node is coupled to more than, for example, six (6) automation components, it may be desirable to deploy a repeater automation component or node near the parent automation component. The repeaters may, in turn, pick-up or coordinate the excess coupled automation components to relieve the parent automation component.

Based on the data gathered in the previous steps, the following adjustments can be made to the wireless network 118a, 118b to optimize its wireless communication: (1) additional wireless repeater nodes or automation components may be added to the wireless networks 118a, 118b; (2) the wireless networks 118a, 118b may be migrated to a different radio channel; (3) the wireless transceivers connected to automation devices may be relocated around intervening obstacles, such as, for example, ductwork, etc.; and (4) a larger network may be divided into two or more smaller (and typically physically closer and contiguous) networks.

It should be understood that various changes and modifications to the presently preferred embodiments described herein will be apparent to those skilled in the art. For example, the elements of these configurations could be arranged and interchanged in any known manner depending upon the system requirements, performance requirements, and other desired capabilities. In yet another example, the functionality deployed on the mobile device 400 may be deployed and utilized on one or more of the full function devices. In yet another embodiment, the functionality deployed on the mobile device 400 may be automatically triggered and operated throughout the set up, configuration and installation of the control system 100. Well understood changes and modifications can be made based on the teachings and disclosure provided by the present invention and without diminishing from the intended advantages disclosed herein. It is therefore intended that such changes and modifications be covered by the appended claims.

What is claimed is:

1. A method of verifying placement of automation components configured for use within a building automation system, the method comprising:
determining a wireless communication channel for use within a building automation system;
polling a plurality of automation components deployed within the building automation system, wherein each of the plurality of automation components utilizes the wireless communication channel for communication;
determining communication parameters associated with each of the plurality of automation components; and
adjusting the deployment of at least one of the plurality of automation components in response to the determined communication parameters.

2. The method of claim 1, wherein determining communication parameters includes determining at least an average communication response time between a first and second of the plurality of automation components.

3. The method of claim 2, wherein the first of the plurality of automation components includes a full function device and the second of the plurality of automation component includes a reduced function device.

4. The method of claim 1, wherein determining communication parameters includes determining a number of neighboring components in communication with each of the plurality of automation components.

5. The method of claim 1, wherein determining communication parameters includes determining a communication route between a first of the plurality of automation components and a second of the plurality of automation components.

6. The method of claim 5, wherein the first of the plurality of automation components is a full function device and the second of the plurality of automation component is a reduced function device.

7. The method of claim 1, wherein determining communication parameters includes determining a number of automation components associated with at least one of the plurality of automation components.

8. The method of claim 1, wherein adjusting the deployment of at least one of the plurality of automation components includes an adjustment selected from the group consisting of: providing additional wireless repeater nodes or automation components; migrating communications to a different wireless communication channel; relocating one or more of the automation components; and grouping automation components to form smaller mesh networks.

9. A mobile device for verifying placement of automation components within a building automation system, the device comprising:
a processor in communication with a memory, the processor configured to:
determine a wireless communication channel for use within a building automation system in response to a communicated scan command;
poll a plurality of automation components deployed within the building automation system, wherein each of the plurality of automation components utilizes the wireless communication channel for communication; and
determine communication parameters associated with each of the plurality of automation components.

10. The device of claim 9 wherein the processor is further configured to:
provide adjustment information for adjusting the position of at least one of the plurality of automation components in response to the determined communication parameters.

11. The method of claim 10, wherein adjusting the position of at least one of the plurality of automation components includes an adjustment selected from the group consisting of: providing additional wireless repeater nodes or automation components; migrating communications to a different wireless communication channel; relocating one or more of the automation components; and grouping automation components to form smaller mesh networks.

12. The device of claim 9, wherein the communication parameters includes at least an average communication response time between a first and second of the plurality of automation components.

13. The device of claim 12, wherein the first of the plurality of automation components includes a full function device and the second of the plurality of automation component includes a reduced function device.

14. The device of claim 9, wherein the communication parameters includes a number of neighboring components in communication with each of the plurality of automation components.

15. The device of claim 9, wherein the communication parameters includes a communication route between a first of the plurality of automation components and a second of the plurality of automation components.

16. The device of claim 15, wherein the first of the plurality of automation components is a full function device and the second of the plurality of automation component is a reduced function device.

17. The device of claim 9, wherein the communication parameters includes a number of automation components associated with at least one of the plurality of automation components.
